(19) United States
(12) Patent Application Publication
(10) Pub. No.: US 2026/0111841 A1
(43) Pub. Date: Apr. 23, 2026

(54) SYSTEMS AND METHODS FOR AUDITABLE RFID COUNTS

(71) Applicant: Datascan, Coppell, TX (US)

(72) Inventors: Herb Billings, III, Coppell, TX (US); Marc Fukuda, Coppell, TX (US)

(21) Appl. No.: 19/364,311

(22) Filed: Oct. 21, 2025

Related U.S. Application Data
(60) Provisional application No. 63/709,736, filed on Oct. 21, 2024.

(51) Int. Cl. G06Q 10/087; G06K 7/14

(52) U.S. Cl. CPC G06Q 10/08772; G06K 7/1413

(57) ABSTRACT

Systems and methods for an auditable RFID count may be provided. This may add a layer of trust which may be otherwise difficult to achieve with a typical RFID count. These systems and methods may be executed by a counting service or by the business itself. Trust may be achieved from the ability to audit RFID counts as easily as is possible in a barcode counting system and the ability to identify classes of items with unreadable or non-existent tags.

### CROSS-REFERENCE TO RELATED APPLICATION

The present Application is a non-provisional of, and claims priority to, U.S. Patent Application No. 63/709,736 filed Oct. 21, 2024, the disclosure of which is incorporated by reference in its entirety.

### FIELD OF THE DISCLOSURE

The present disclosure generally relates to radio-frequency identification (RFID) counting, and more particularly to auditable RFID counts.

### BACKGROUND

RFID technology enables rapid inventory counts in a wide range of environments, including, but not limited to retail stores, storage rooms, warehouses, manufacturing facilities, and healthcare institutions. RFID technology spectacularly delivers on the “fast counts” promise but can be a little short on “trusted counts” for special use cases such as an annual audit count in a retail chain. The accuracy of RFID reads is not in question - if the RFID reader detects the RFID tag, then the captured data is considered accurate. However, tags which are not read create potential for significant inaccuracies. This includes items without tags, items out of the reader's range, and interference from metal and liquid. It can be difficult to trust that all items are counted in environments where some product families are known to not have RFID tags. To be sure, RFID delivers a higher level of accuracy for operational adjustments where businesses update their stock on hand levels to improve their inventory record accuracy. Missed reads are often caught and corrected in the next cycle count which is usually conducted weekly. With inaccuracies often lasting only a week, this level of accuracy works very well to support daily operational requirements. But the potential inaccuracies make many businesses reluctant to use a single RFID count to generate financial adjustments, such as those associated with auditor-required annual physical inventories.

### SUMMARY

Embodiments of the present disclosure may provide systems and methods for auditable RFID counting comprising starting a count; performing an RFID read of all items associated with each location tag; associating the RFID read with a most likely location tag; comparing the RFID read to onhands to identify any locations required to be re-read with RFID; performing any RFID re-reads of any locations required to be re-read with RFID; merging the RFID read and any RFID re-reads; and completing the count by creating a final count file.

The systems and methods may further comprise performing a barcode scan of at least one stock keeping unit (SKU) in each product family associated with each location tag, wherein the barcode scan is performed at or around the time when the RFID read step is performed; comparing the RFID read to the barcode scan; and performing barcode counts, wherein the barcode scan is merged with the RFID read and any RFID re-reads. A file containing SKUs and associated locations may be used in lieu of performing the barcode scan.

Systems and methods may further comprise performing one or more audit counts of the merged reads. This audit count may include selecting a location to audit; reporting unit counts for all SKUs associated with the location either by RFID reads or by barcode counts; and reviewing the unit counts and modifying as needed.

Each location tag may have a printed barcode, a human-readable location identifier, a non-repeating serial number unique with a business location, and optionally RFID or other wireless technology. Starting the count may use temporary location tags and/or permanent location tags through manual entry and/or automated entry. The method also may include affixing temporary location tags to all locations in an area to be counted; entering all used location tags; and entering a scope of the count. The method also may include entering all used location tags; and entering a scope of the count. The method also may include entering a scope of the count; starting the count; and loading location tags and optionally location tag groups from a known set of permanent tags.

The performing an RFID read of all items associated with each location tag step may further comprise: scanning a location tag barcode or reading a location tag chip to indicate a location being counted; analyzing incoming unique reads per second; and providing a visual and/or audio indication when scanning or reading is to stop by combining incoming unique reads per second with minimum and maximum read times. The associating the RFID read with a most likely location tag step may further comprise: evaluating if all product families are processed; if not all product families are processed, obtaining an RFID read along with barcode scan information for a next product family; evaluating whether the next product family is in the count scope; if not in the count scope, determining if the next product family is found on any barcode scan locations; and if the next product family is found, associating a location of the barcode scan for the product family to all item instances in the next product family. The associating step may further comprise for each SKU within the product family, associating a location of a best RFID read of any item instance within that SKU.

The comparing the RFID read to onhands to identify any locations required to be re-read with RFID step may further comprise: identifying SKUs and/or product families that may have been undercounted; and when a variance exceeds a threshold, scheduling RFID re-reads for all locations associated with the SKUs and/or product families. The performing any RFID re-reads of any locations required to be re-read with RFID step may further comprise: if not all locations are read, performing a barcode scan, an electronic read, and/or manual entry of the location tag; performing an RFID read of items in an area defined by the location tag; closing location tag reads; and uploading location data. The merging the RFID read and any RFID re-reads step may further comprise: adding new item instances found in the RFID re-reads to the RFID read; associating all RFID reads with location tags, overwriting any previous associations; deleting any barcode counts for SKUs with any number of RFID reads; and merging associated RFID reads with cleaned barcode counts to create final counts.

### BRIEF DESCRIPTION OF THE DRAWINGS

For a more complete understanding of this disclosure, reference is now made to the following description, taken in conjunction with the accompanying drawings, in which:

FIG. 1 depicts a flow chart of an auditable RFID counting method according to an embodiment of the present disclosure;

FIGS. 2A-2C depict a step of starting the count for temporary location tags and permanent location tags according to embodiments of the present disclosure;

FIG. 3 depicts an optional process to perform barcode scans according to an embodiment of the present disclosure;

FIG. 4 depicts a process for performing RFID reads according to an embodiment of the present disclosure;

FIG. 5 depicts a process to associate RFID reads to location tags according to an embodiment of the present disclosure;

FIG. 6 depicts a process to compare RFID to onhands according to an embodiment of the present disclosure;

FIG. 7 depicts a process to compare RFID to barcode scans or location/SKU according to an embodiment of the present disclosure;

FIG. 8 depicts a process to perform full barcode counts according to an embodiment of the present disclosure;

FIG. 9 depicts a process to perform RFID re-reads according to an embodiment of the present disclosure;

FIG. 10 depicts a process to merge RFID reads and barcode counts according to an embodiment of the present disclosure;

FIG. 11 depicts performing audit counts according to an embodiment of the present disclosure;

FIG. 12 depicts completion of the count according to an embodiment of the present disclosure;

FIG. 13 depicts a flow chart of an RFID counting method according to an embodiment of the present disclosure;

FIGS. 14A-14C depict a step of starting the count for temporary location tags and permanent location tags according to embodiments of the present disclosure;

FIG. 15 depicts a step of performing unit counts according to an embodiment of the present disclosure;

FIG. 16 depicts a step of performing a unit count in one location according to an embodiment of the present disclosure;

FIG. 17 depicts a step of performing RFID reads according to an embodiment of the present disclosure;

FIG. 18 depicts a step of performing an RFID at one location according to an embodiment of the present disclosure;

FIG. 19 depicts a step of associating RFID tags to location tags according to an embodiment of the present disclosure;

FIG. 20 depicts a step of comparing RFID to unit counts according to an embodiment of the present disclosure;

FIG. 21 depicts a step of resolving rejected locations according to an embodiment of the present disclosure;

FIG. 22 depicts a step of resolving a rejected location according to an embodiment of the present disclosure;

FIG. 23 depicts a step a barcode scan of one location according to an embodiment of the present disclosure;

FIG. 24 depicts a step of resolving invalid barcodes according to an embodiment of the present disclosure;

FIG. 25 depicts a step of resolving SKUs counted both ways according to an embodiment of the present disclosure; and

FIG. 26 depicts a step of completing the count according to an embodiment of the present disclosure.

### DETAILED DESCRIPTION

Embodiments of the present disclosure may provide an auditable RFID count, adding a layer of trust which may be otherwise difficult to achieve with a typical RFID count. These systems and methods may be executed by a counting service or by the business itself. Trust may be achieved from the ability to audit RFID counts as easily as is possible in a barcode counting system and the ability to identify classes of items with unreadable or non-existent tags.

As means of orientation, the term “application” may refer to any and all components of the system according to embodiments of the present disclosure, whether the function is specific to the RFID reader, a mobile computer, a barcode scanner, and/or cloud computing services. The term “counting service” may mean either an outside counting service or the business itself. The term “item instance” describes a single unit in a stock keeping unit (SKU). A SKU is a unique identifier used to track a specific product configuration within a business and may represent a distinct combination of attributes such as type, size, color, and other variations that differentiate one product from another in inventory systems. For example, in a retailer with RFID tags, the Electronic Product Code (EPC) is a unique global identifier which distinguishes between two otherwise identical items. A “product family” may be a group of related SKUs that share common characteristics or functions but differ in specific attributes. Using apparel as an example, a style can be considered a product family, as each style typically contains various colors and sizes, each with its own SKU. A product family may include one or more SKUs which may include one or more item instances. “Location tags” may be used to divide the area to be counted into small sections to facilitate any subsequent audit process. The identifier printed on or encoded into the location tag is unique within the area to be counted. The identifier may be numeric or alphanumeric. “Onhands” are current units of SKUs at a specific location which are in stock and ready for use, sale, or distribution, according to an inventory management system.

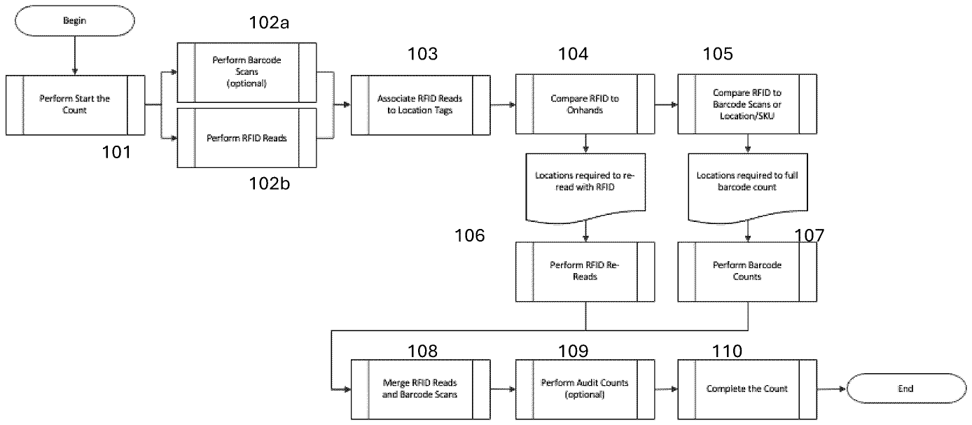

FIG. 1 depicts a flow chart of an auditable RFID counting method according to an embodiment of the present disclosure. The count may be started by entering the used (expected) locations and count scope into the application 101. A user may scan the barcodes of at least one SKU in every product family associated with each location tag 102a. Alternatively, the business may provide a file containing SKUs and associated locations. RFID counters read all items associated with each location tag 102b. Once all barcode scans and RFID reads are complete, the application associates all RFID reads with their most likely location tag 103. A program compares the RFID reads to onhands to report the locations required to re-read with RFID 104. A program compares the RFID reads to the barcode scans to report the locations required to barcode count 105. Locations required to perform a full barcode count then perform barcode counts 107. A user scans the barcodes of all item instances of all SKUs on locations required to barcode count. Locations required to re-read with RFID will then perform RFID re-reads 106. RFID counters read all items associated with each location required to be re-read. A program merges the RFID reads, RFID re-reads, and barcode scans in a way that does not duplicate items counted by both RFID reads and barcode scans 108. At this point, a user may choose to perform audits of the combined RFID and barcode counts 109. At the end of the process, the count is completed; the application creates a final count file and delivers it to the business via any agreed-upon transfer method 110. The method according to embodiments of the present disclosure may be designed to scale across various industries and facility types, supporting inventory counts for any item or product family that can be tagged and tracked using RFID and barcode technology.

Location tags will have both a printed barcode and the human-readable location identifier printed on them. Location tags may optionally contain RFID or other wireless technology with the location identifier. Each location identifier contains a non-repeating serial number unique within this business location.

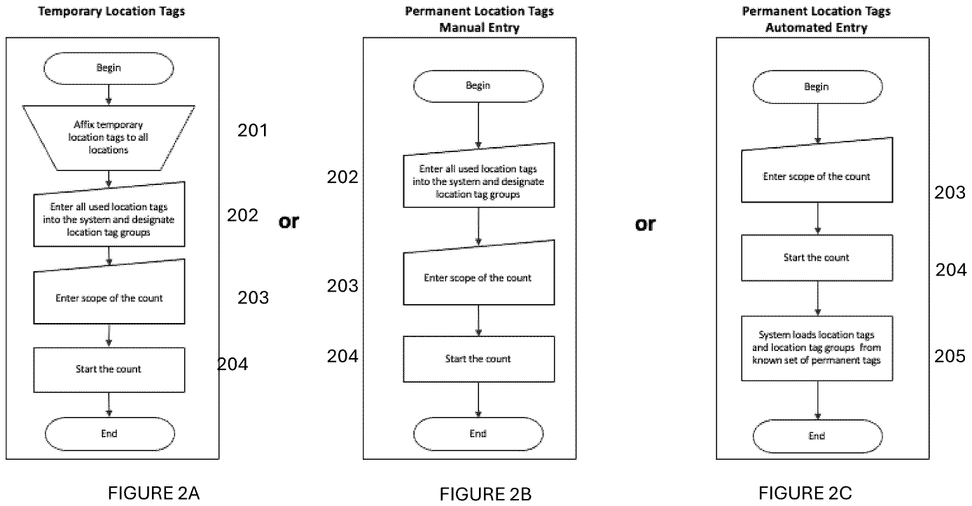

Location tags are used to divide the entire space to be counted into more manageable and referenceable locations. Their placement should represent an identifiable physical location in a consistent way such that it is obvious which items belong to which location tags. The counting service must enter the scope of the count. This means defining which product families are included in the count. The specification of what is included in the count is either all items, or desired categories of product families. There are two variations regarding location tags: temporary and permanent, and these variations are reflected in FIGS. 2A-2C.

FIG. 2A depicts use of temporary location tags where the counting service affixes temporary location tags to fixtures throughout the area to be counted prior to each count. As depicted herein, temporary tags may be affixed to all locations 201. All used location tags may be entered into the system and location tag groups optionally may be designated 202. The scope of the count is entered 203. The count is then started 204.

FIGS. 2B-2C depict using permanent location tags where the business affixes permanent location tags to fixtures throughout the business location once when initially implementing the system. FIG. 2B depicts use of permanent location tags with manual entry. As depicted herein, the process may begin at step 202 where all used location tags may be entered into the system and location tag groups optionally may be designated 202. The scope of the count is entered 203. The count is then started 204. FIG. 2C depicts use of permanent location tags with automated entry. As depicted herein, the process may begin at step 203 where the scope of the count is entered. The count is then started 204. The system may load location tags and optionally location tag groups from a known set of permanent tags 205.

Whether temporary or permanent location tags are used, the counting service must record the used location tag numbers in the system to measure counting progress and to determine when all location tags have been completed. When using permanent location tags, it is possible for the system to automatically load a known set of location tags.

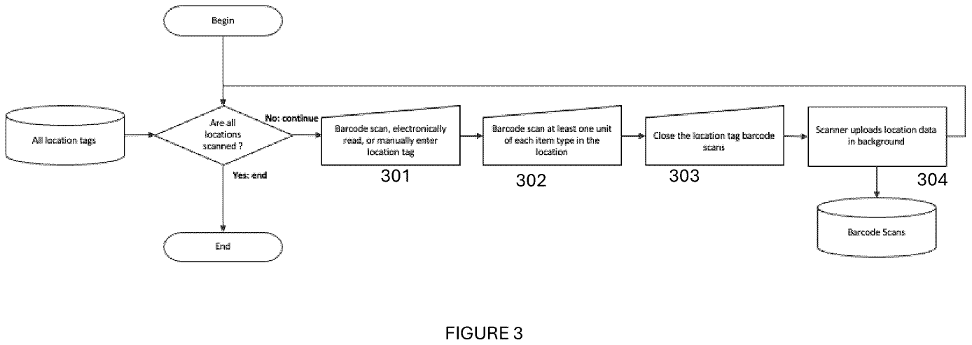

FIG. 3 depicts an optional process to perform barcode scans according to an embodiment of the present disclosure. It should be appreciated that this process is not needed if the business can provide SKUs by location information (i.e., through a detailed planogram). A user with a barcode reader scans the location tag's barcode or reads the location tag's chip to indicate the location being scanned. The user then scans at least one barcode from each product family. Once all product families are scanned, the user completes the location, and the application uploads the data in the background without user intervention. More specifically, if not all locations are scanned, there may be a barcode scan, electronic read, or manual entry of location tag 301. At least one unit of each item type in the location then may be barcode scanned 302. The location tag barcode scans are then closed 303. The scanner uploads location data in the background 304.

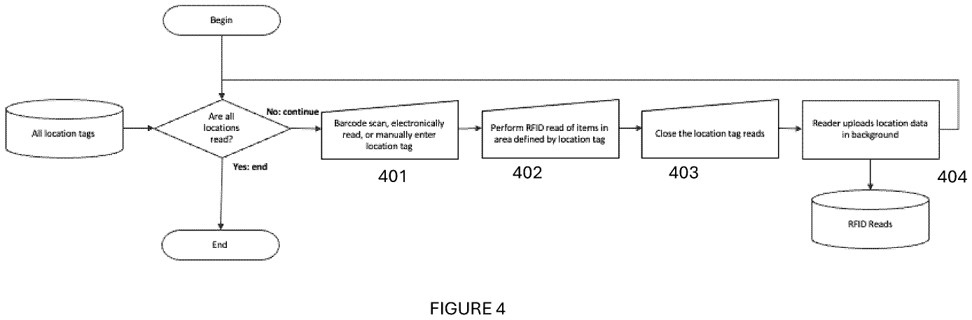

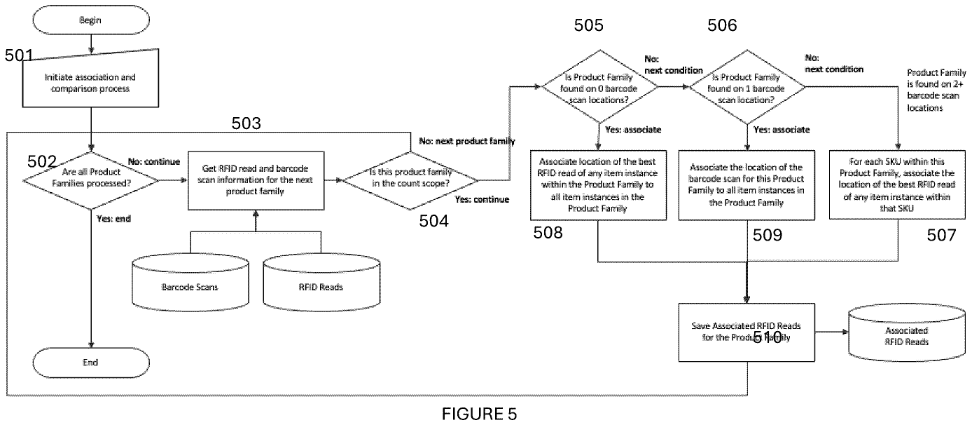

FIG. 4 depicts a process for performing RFID reads according to an embodiment of the present disclosure. A user with a mobile RFID reader scans a location tag's barcode or reads a location tag's chip to indicate the location being counted. The user begins an RFID read either by engaging the trigger or via a touchscreen button and waves the mobile RFID reader near the items belonging to the location tag. Alternatively, the RFID read function may commence automatically after successfully scanning the location tag. The application analyzes incoming unique reads per second and when combined with minimum and maximum read times provides a visual and audio indication when the user may stop reading tags. The user may choose to continue to read after receiving the OK to stop, but the user may not stop reading before the application allows. The user stops the RFID read either by releasing the trigger or via a touchscreen button. Once finished reading the location's RFID tags, the user completes the location, and the application uploads the data in the background without user intervention. The location's tag number, start time, and end time, along with each RFID tag's encoded information, number of reads, average and peak signal strength are all uploaded to the server. Note that this collection of RFID tag reads will contain more than the specific items visually associated with the location tag as RFID technology can read tags many feet away. More specifically, if not all locations are read, then there may be a barcode scan, electronic read, or manual entry of a location tag 401. The RFID read may be performed of items in areas defined by the location tag 402. The location tag reads are then closed 403, and the reader uploads location data in the background 404.

FIG. 5 depicts a process to associate RFID reads to location tags according to an embodiment of the present disclosure. A user initiates the association and comparison process after all barcode scans and RFID reads are completed 501. The application associates each RFID tag with exactly one location tag using the RFID read attributes obtained during the RFID read process, and either barcodes scanned in the barcode scanning process or the business' SKU/location data if available. The association process works by product family. It uses the concept of “best RFID read” which is defined as the RFID tag read with the highest average RSSI (Relative Signal Strength Index), highest peak RSSI, and highest tag read count. If the count scope is less than the entire inventory, the application drops any RFID read which is not within the count scope. If the product family was not scanned in any location, the application determines the best RFID read of any item instance within the product family. The application then associates all item instances within the product family to this read's location tag. In other words, all item instances of this product family are associated with only one location. If the product family was scanned in only one location, the application associates all item instances within the product family to the barcode scan's location tag. In other words, all item instances of this product family are associated with only one location. If the product family was scanned on more than one location, the application associates the location of the best RFID read of any item instance in each SKU to all item instances of each SKU. In other words, item instances of each SKU within this product family are associated with only one location. Note that the product family in this condition may be associated with multiple locations.

More specifically, after the association and comparison process is initiated 501, an evaluation is made as to whether all product families are processed 502. If not all are processed, an RFID read will be obtained along with barcode scan information for the next product family 503. An evaluation then may be made as to whether the product family is in the count scope 504. If not, then the process may proceed to the next product family to determine if the product family is found on 0 barcode scan locations 505. If it is found, the process may proceed to associate the location of the best RFID read of any item instance within the product family to all item instances in the product family 508. If not, the process may proceed to evaluate if the product family is found on 1 barcode scan location 506. If it is found, the process may proceed to associate the location of the barcode scan for this product family to all item instances in the product family 509. If not, the next condition may identify if the product family is found on 2+ barcode scan locations. For each SKU within the product family, the location of the best RFID read of any item instance within that SKU is associated 507. The associated RFID reads for the product family may then be saved 510.

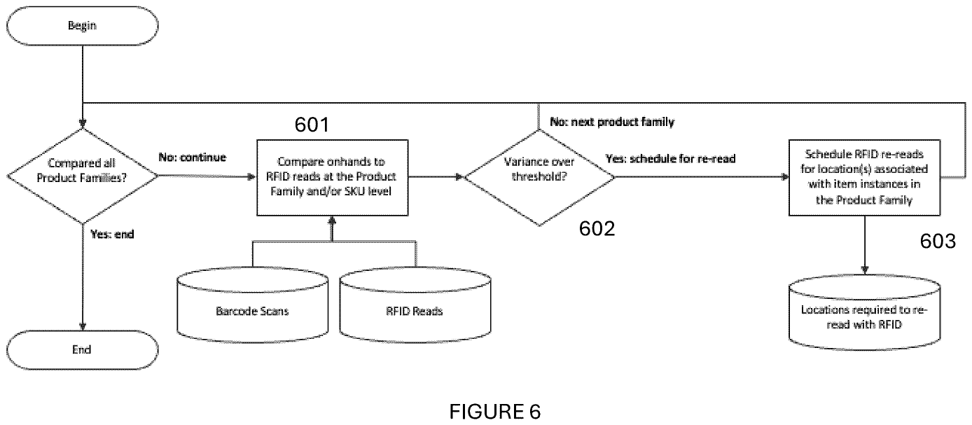

FIG. 6 depicts a process to compare RFID to onhands according to an embodiment of the present disclosure. If not compared with all product families, the application compares RFID reads to onhands to identify SKUs and/or product families which may have been undercounted 601. SKU-level variances are used whenever the expected counts are relatively high at the SKU level. Product Family-level variances are used whenever the expected counts at the SKU level are relatively low. When the variance exceeds a threshold 602, the application schedules RFID re-reads for all locations associated with the SKU or Product Family 603.

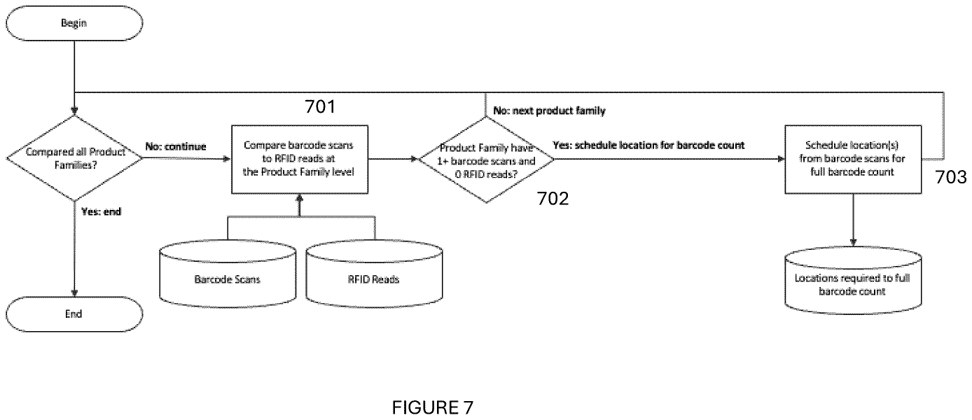

FIG. 7 depicts a process to compare RFID to barcode scans or location/SKU according to an embodiment of the present disclosure. If not all product families are compared, the application compares RFID reads to barcode scans to identify product families without RFID tags or product families which have unreadable RFID tags 701. All locations associated with product families which have at least one barcode scan, but zero RFID reads will be identified 702 and scheduled for a full barcode count 703. Alternatively, the list of locations may be limited to product families with variances to onhands over a threshold.

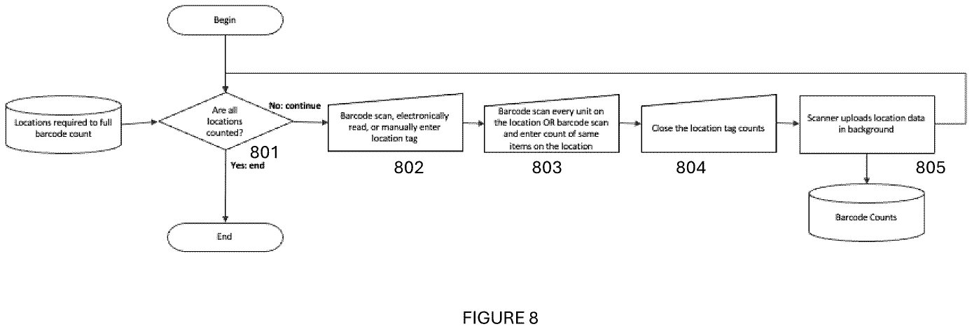

FIG. 8 depicts a process to perform full barcode counts according to an embodiment of the present disclosure. A user with a barcode reader scans the location tag's barcode or reads the location tag's chip to indicate the location being scanned. The user then barcode scans the first SKU, manually counts all units of the same SKU, enters the units counted, and repeats until all items on the location have been counted. Alternatively, the user may barcode scan each SKU in single-scan mode (units=1 for each scan) until all items on the location have been counted. Once all items on the location have been counted, the user completes the location and the application will upload the captured data in the background without user intervention. Note that it is possible to have a location containing product families with RFID tags mixed in with product families without RFID tags. All barcodes are scanned in this step, freeing the counters from having to determine which items must be barcode scanned. Duplicate counts are handled in a later step.

More specifically, as depicted herein, an evaluation may be made as to whether all locations are counted 801. If not, a barcode scan, electronic read, or manual entry of a location tag may be performed 802. A barcode scan may be performed on every unit on the location or a barcode scan and the count of the same items on the location may be entered 803. The location tag counts are then closed 804, and the scanner uploads location data in the background 805.

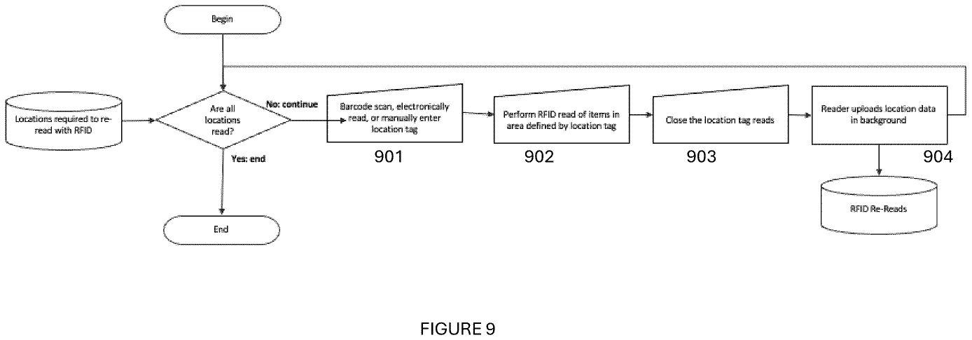

FIG. 9 depicts a process to perform RFID re-reads according to an embodiment of the present disclosure. A user with a mobile RFID reader scans a location tag's barcode or reads a location tag's chip to indicate the location being counted. The user begins an RFID read either by engaging the trigger or via a touchscreen button and waves the mobile RFID reader near the items belonging to the location tag. Alternatively, the RFID read function may commence automatically after successfully scanning the location tag. The application analyzes incoming unique reads per second and when combined with minimum and maximum read times provides a visual and audio indication when the user may stop reading tags. The user may choose to continue to read after receiving the OK to stop, but the user may not stop reading before the application allows. The user then stops the RFID read either by releasing the trigger or via a touchscreen button. Once finished reading the location's RFID tags, the user completes the location, and the application uploads the data in the background without user intervention. The location tag's number, start time, and end time, along with the RFID tag's encoded information, number of reads, average and peak signal strength are all uploaded to the server. Note that this collection of RFID tag reads will contain more than the specific items visually associated with the location tag as RFID technology can read tags many feet away.

More specifically, as depicted herein, if not all locations are read, there may be a barcode scan, electronic read, or manual entry of a location tag 901. An RFID read of items in the area defined by the location tag is performed 902. The location tag reads are then closed 903, and the reader uploads location data in the background 904.

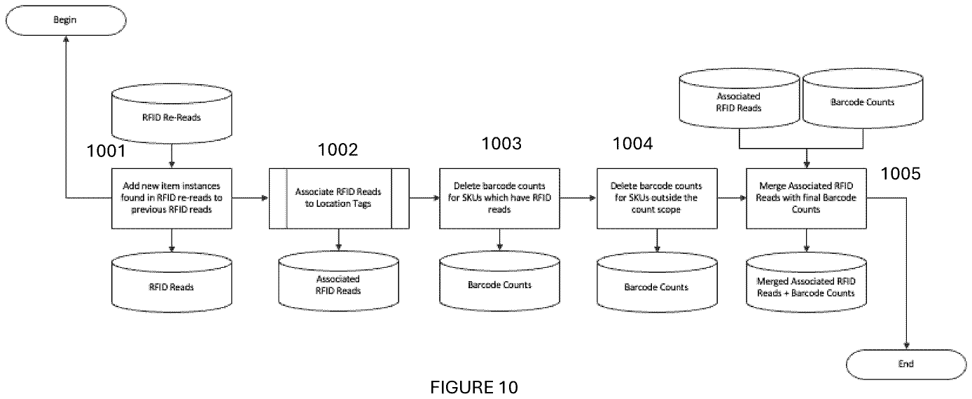

FIG. 10 depicts a process to merge RFID reads and barcode counts according to an embodiment of the present disclosure. The application adds new item instances found in the RFID re-reads to the previous RFID reads 1001. The application then associates all RFID reads with location tags, overwriting the previous associations 1002. The application deletes any barcode counts for SKUs with any number of RFID reads 1003. This step prevents double-counting the same item instances with both RFID reads and barcode scans. The application deletes any barcode counts for SKUs outside the count scope 1004. The application combines/merges the associated RFID reads with the cleaned barcode counts to create the final counts 1005.

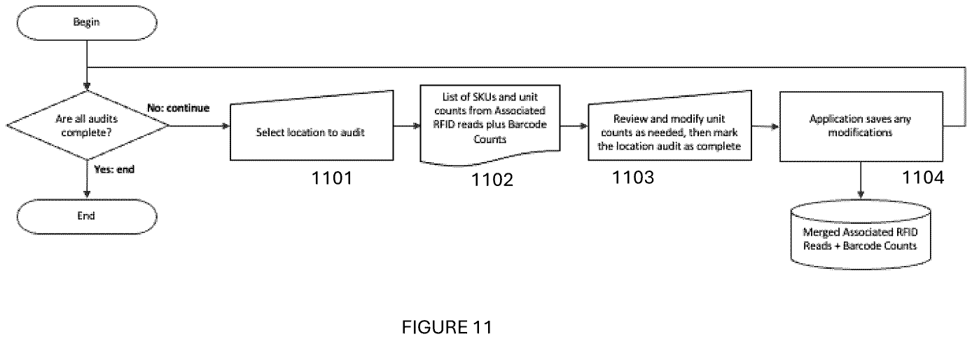

FIG. 11 depicts performing audit counts according to an embodiment of the present disclosure. It should be appreciated that this step is optional. A user selects the location to audit 1101. The application reports unit counts for all SKUs associated with this location either by RFID reads or by barcode counts; this may include a list of SKUs and units counts plus barcode counts 1102. The user reviews the unit counts and modifies if necessary 1103. Any modified counts are saved 1104.

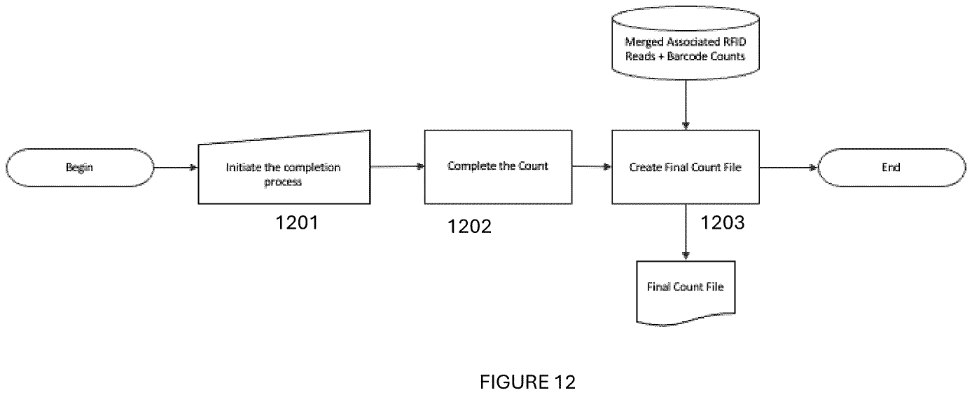

FIG. 12 depicts completion of the count according to an embodiment of the present disclosure. A user with the counting service completes the count after RFID reads and barcode counts are merged, and any optional audit functions are performed. The application marks the count as complete so that no further changes may be made to the counts, then creates the final count file to send to the business via any agreed-upon transfer method. More specifically, the completion process may be initiated 1201. The count may be completed 1202, and the file count file may be created 1203.

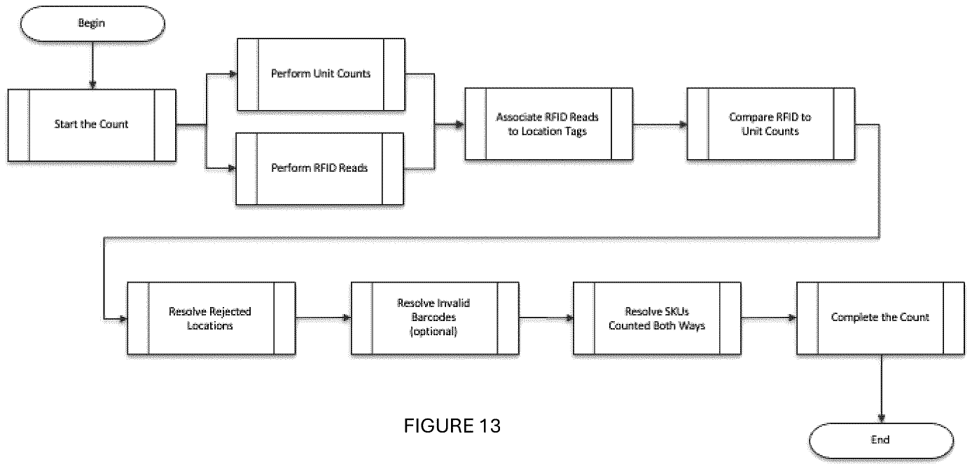

Improved RFID accuracy in counting may be provided in some embodiments of the present disclosure. FIG. 13 depicts a flow chart of an RFID counting method according to an embodiment of the present disclosure. As depicted herein, an RFID count may be started. A unit count may be performed. Additionally, RFID reads may be performed. Once the unit count and/or RFID reads are performed, RFID reads may be associated to location tags. The RFID reads may be compared to unit counts. Rejected locations may be resolved. Invalid barcodes may be reported and resolved. SKUs may be counted both ways to resolve the SKUs, and the count may be completed. Each step within the flow chart of FIG. 13 are further described below.

Location tags may be used to divide a space to be counted into small sections to facilitate the validation process. The business may affix permanent locations tags with barcodes throughout the area to be counted. This step may be performed only once in an embodiment of the present disclosure. If not using permanent location tags, a counting service may affix temporary location tags throughout the area to be counted. The counting service may record the location tags and location tag groups used in the count system, whether they are permanent or temporary. Physical counters may manually count all units associated with each location tag. RFID counters may read all items associated with each location tag. The manual count and RFID read steps may be performed serially by the same person or simultaneously by different persons in embodiments of the present disclosure. Once all unit counts and RFID reads are complete, a program may associate all RFID reads with their most likely location tag. A program may compare the unit count to the total RFID tags assigned to each location tag. The program may accept or reject locations based on a tolerance threshold. Locations rejected by the unit comparison must be resolved by verifying the location's total units, re-reading the RFID tags on the location, and/or scanning all barcodes on the location. Optionally, invalid barcodes may need to be resolved if it makes sense for the business. Some businesses are situated such that the RFID range may extend into the next business' location. In this case, it may not make sense to research all reads which are not in the business' item master file. The counting service may confirm all counts for all SKUs counted by both RFID and barcode data capture methods. Once all rejected RFID locations, all invalid barcodes resolved (if invalid barcode resolution is required), and all SKUs counted both ways have been resolved, a user may close the count to generate a count file for the business.

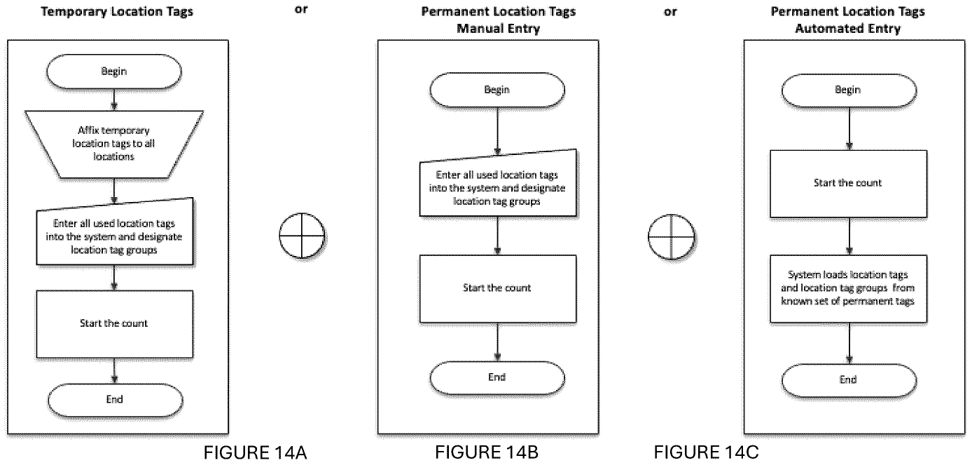

Location tags will have both a printed barcode and the human-readable location identifier printed on them. Location tags may optionally contain an RFID or BLE chip encoded with the location identifier. Each location identifier contains a non-repeating serial number unique within this business location. Location tags may be used to divide the entire space to be counted into more manageable and referenceable locations. Their placement should represent an identifiable physical location in a consistent way such that it is evident which items belong to which location tags. There are two variations regarding location tags: temporary and permanent. When using temporary location tags (FIG. 14A), the counting service affixes temporary location tags to fixtures throughout the area to be counted prior to each count. When using permanent location tags (FIGS. 14B and 14C), the business may affix permanent location tags to fixtures throughout the business location once when initially implementing the system. Whether temporary or permanent location tags are used, the counting service must record the used location tag numbers in the system to measure counting progress and to determine when all location tags have been completed. When using permanent location tags, it is possible for the system to automatically load a known set of location tags. The counting service must also designate location groups in the system, which are locations located physically close to other locations such that it's hard to distinguish the boundaries between them.

FIGS. 14A-14C depict the step of starting the count for temporary location tags (FIG. 14A) and permanent location tags (FIGS. 14B-14C) according to embodiments of the present disclosure. As depicted in FIG. 14A, temporary location tags may be affixed to all locations. All used locations tags may be entered into a system and location tag groups may be designated. The count may then be started. As depicted in FIG. 14B, permanent location tags may be used in a manual entry context. All used location tags may be entered into a system and location tag groups may be designated. The count may then be started. In FIG. 14C, permanent location tags may be used in an automated entry context. The count may be started, and the system may load location tags and location tag groups from a known set of permanent tags.

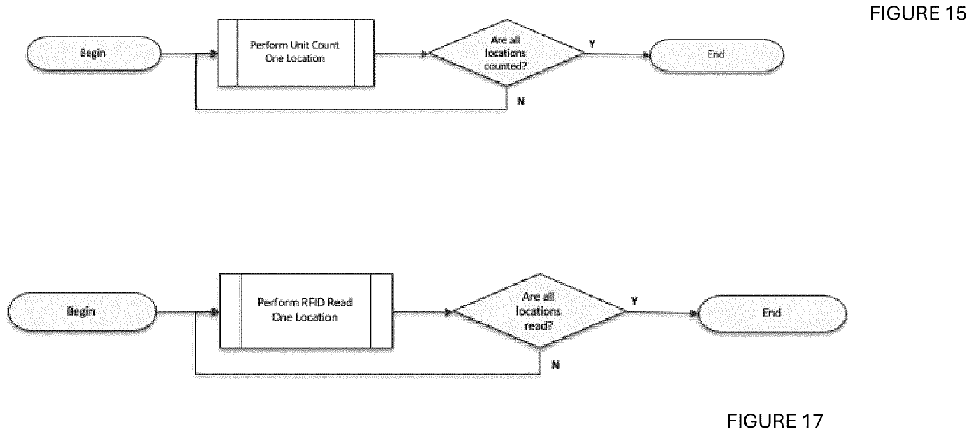

FIG. 15 depicts a step of performing unit counts according to an embodiment of the present disclosure. In this step, a unit count may be performed in one location. An evaluation of whether all locations are counted may be made, and if not all locations have been counted, the step may be repeated until all locations have been counted. A user with a barcode scanner may record unit counts for all locations within the business' area to be counted.

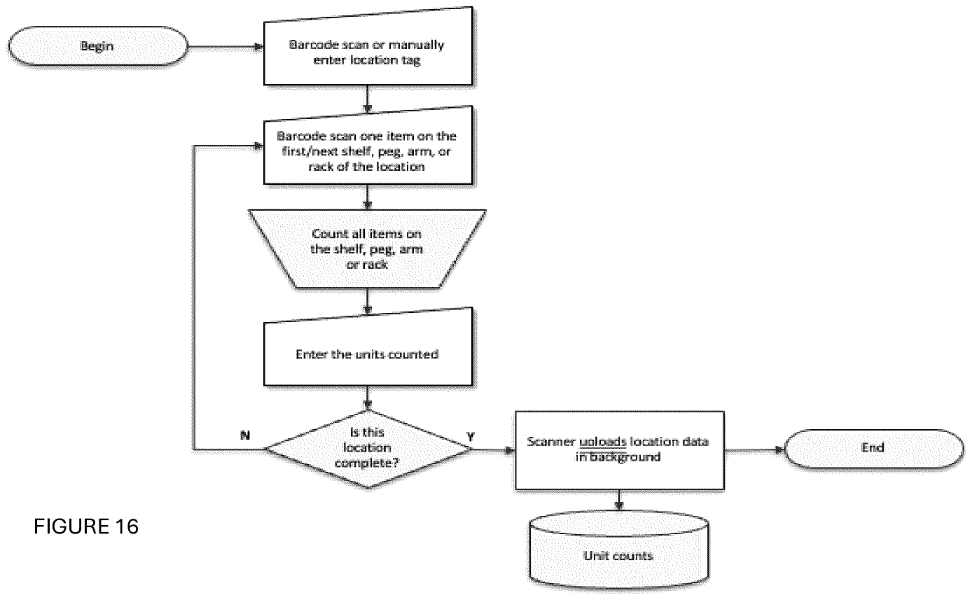

A user with a barcode scanner may start the unit count process by scanning the barcode on the location tag. Units may be counted by scanning the barcode of the first item on a feature of that location (e.g., a shelf, peg, arm, or rack) and the total units counted may be entered into the scanner. Each feature of the location may be counted in this way to increase accuracy by limiting the number of units to remember mid-count. Once the count of the last feature is entered, the user completes the location, and the application uploads the data in the background without user intervention. FIG. 16 depicts a step of performing a unit count at one location according to an embodiment of the present disclosure. A barcode scan may be performed or a location tag may be manually entered. A barcode scan of one item on the first/next shelf, peg, arm, or rack of the location may be performed. All items on the shelf, peg, arm, or rack may be counted. The units counted may be entered. An evaluation as to whether the location is complete is made. If not, the steps previously described in FIG. 16 may be repeated. When complete, the scanner may upload location data in the background. Unit counts may be output.

FIG. 17 depicts a step of performing RFID reads according to an embodiment of the present disclosure. A person using an RFID reader (which may be mobile) may capture RFID reads for all locations within the business' area to be counted. If not all locations are read, the step may be repeated.

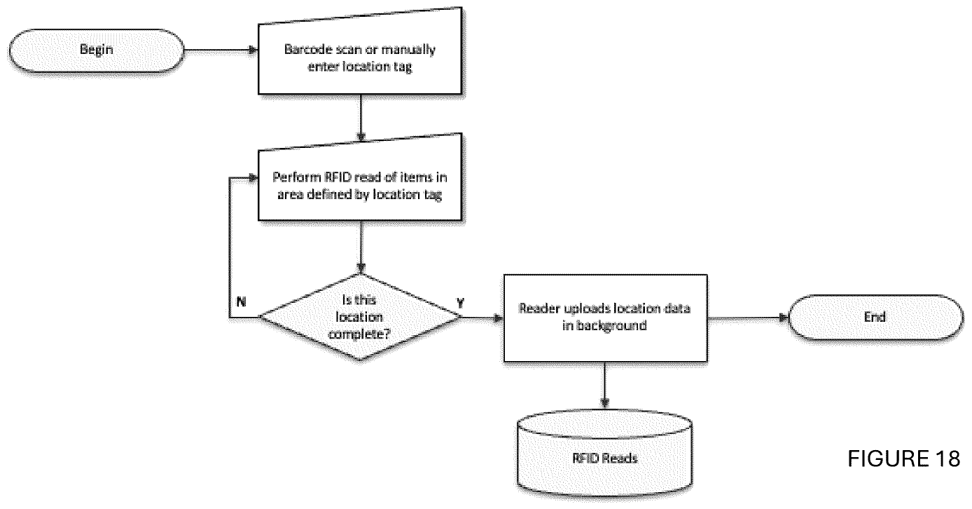

FIG. 18 depicts a step of performing an RFID at one location according to an embodiment of the present disclosure. A user with a mobile RFID reader may scan a location tag's barcode or read a location tag's chip to indicate the location to be counted. The user may begin an RFID read either by engaging the trigger or via a touchscreen button, waving the mobile RFID reader near the items belonging to the location tag, and then stopping the RFID read either by releasing the trigger or via a touchscreen button. Once finished reading the location's RFID tags, the user completes the location, and the application uploads the data in the background without user intervention. A barcode scan may be performed, or a location tag may be manually entered. An RFID read of items in an area defined by the location tag may be performed. An evaluation may be made as to whether to location is complete, and if it is not, the step may be repeated. In an embodiment of the present disclosure, an alert, such as a sound, may be given if the location is complete. The RFID reader may upload location data in the background. The RFID reads may be stored. The location tag number, start time, end time, RFID tag encoded information, number of reads, and/or the signal strength for each RFID tag read may all be uploaded to the server. However, it should be appreciated that more or fewer items associated with the RFID read may be uploaded without departing from the present disclosure. It should be appreciated that this collection of RFID tag reads may contain more than the specific items visually associated with the location tag as RFID technology can read tags many feet away.

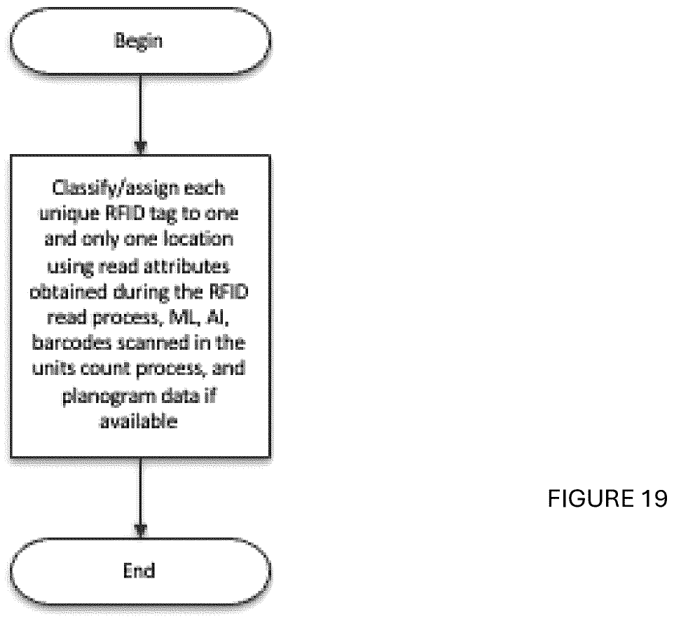

FIG. 19 depicts a step of associating RFID reads to location tags according to an embodiment of the present disclosure. After all location unit counts and RFID reads are uploaded, the server may classify/assign each unique RFID tag to exactly one location tag using read attributes obtained during the RFID read process, ML, AI, barcodes scanned in the units count process, and/or planogram (item/location) data if available.

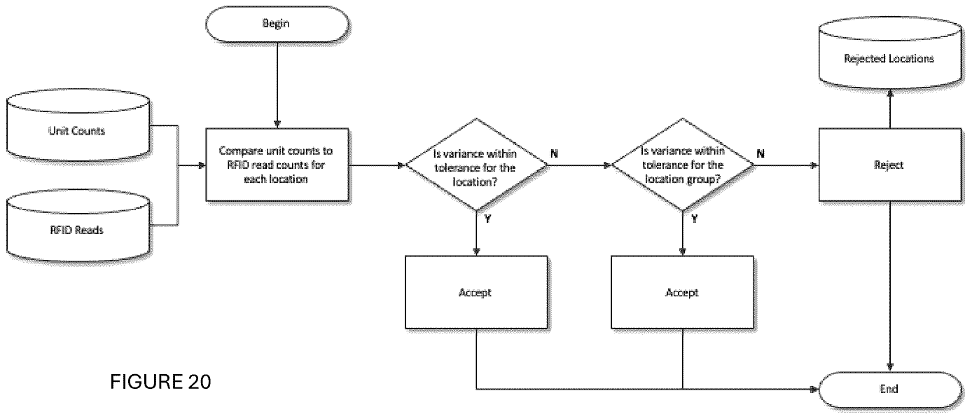

FIG. 20 depicts a step of comparing RFID to unit counts according to an embodiment of the present disclosure. A program on the server may compare each location tag's manual unit count to the total item count assigned to the location. The system will accept the RFID counts under any of the following conditions: the variance between the unit count and RFID assignments for the location is within accepted tolerance; the variance between the unit count and RFID assignments for a group of locations is within accepted tolerance; or other ways to accept RFID counts for a single location or set of locations. If all tests fail, the system will reject the affected location(s). Locations which are accepted by the system require no further review.

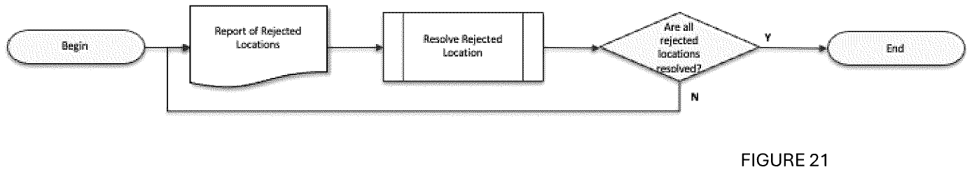

FIG. 21 depicts a step of resolving rejected locations according to an embodiment of the present disclosure. A user may resolve all locations appearing on the Report of Rejected Locations. If not all rejected locations are resolved, the step may be repeated until all rejected locations have been resolved.

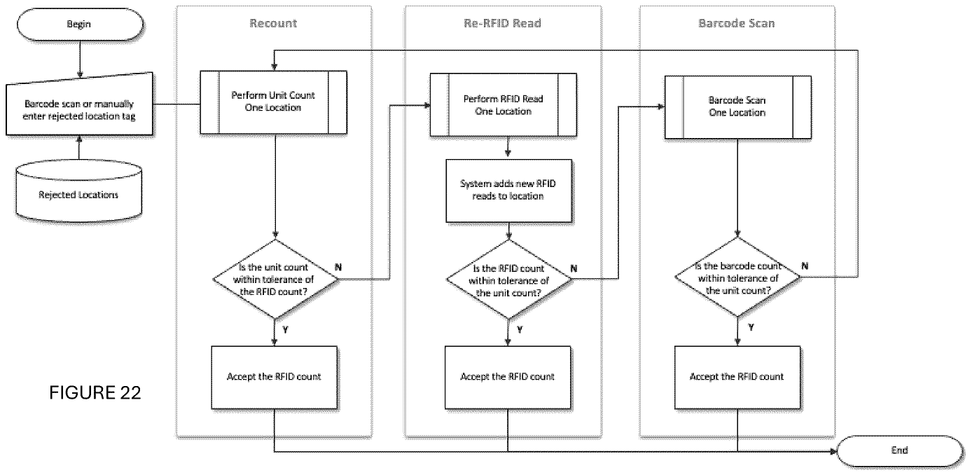

FIG. 22 depicts a step of resolving one rejected location according to an embodiment of the present disclosure. A user with an RFID reader may scan a rejected location tag's barcode, count all items on the location, and enter the total units counted. If the variance between total units counted and the RFID units is within the tolerance threshold, the location's RFID assignments will be accepted. If the variance is still outside the tolerance threshold, the user may perform an RFID read of the location's items. New items read will be added to the RFID count. If the variance between total units counted and the RFID units is within the tolerance threshold, the location's RFID assignments will be accepted. If the variance is still outside the tolerance threshold, the user will perform a barcode scan of the location's items. If the variance between total units counted and the barcode scanned items is within the tolerance threshold, the location's barcode scans will be accepted. If the variance is still outside the tolerance threshold, the user will repeat the process starting from the beginning of the resolve rejected locations process. It should be appreciated that different steps may be specified depending on whether the unit count is greater or less than the RFID count.

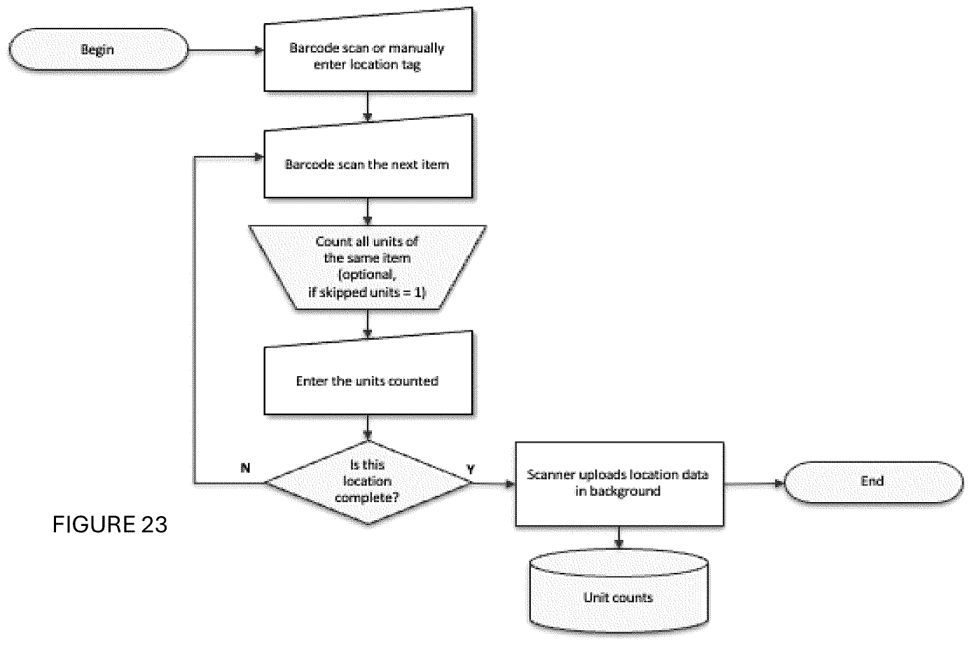

FIG. 23 depicts a step a barcode scan of one location according to an embodiment of the present disclosure. A user with a barcode reader may scan the location tag's barcode. The user will then barcode scan the first item, manually count all units of the same item, enter the units counted, and repeat for all items until all items on the location have been counted. Alternatively, the user may barcode scan each item without counting until all items on the location have been counted. Once all items on the location have been counted, the user completes the fixture, and the application will upload the captured data to the server in the background without user intervention.

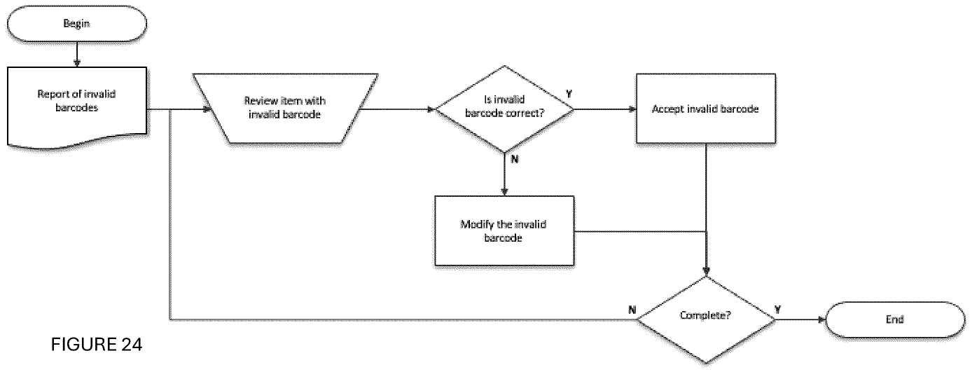

FIG. 24 depicts a step of resolving invalid barcodes according to an embodiment of the present disclosure. The system will report all barcodes not found in the business' list of valid barcodes (item master). The user will be presented with an interface with the following options to resolve each instance: modify the invalid item; or accept the invalid item. As depicted herein, a review of a report with invalid barcodes by location may be performed. Any item containing barcodes not found in the business' list of valid barcodes (item master) may be reported. If the invalid barcode is correct, the invalid barcode may be accepted. If it is not correct, the invalid barcode may be modified. While invalid items may be ignored by the RFID reader program, invalid items still may enter the system through the barcode scan or by manual entry. A user may be presented with an interface with options to resolve each instance including, but not limited to, modify the invalid item, or accept the invalid item.

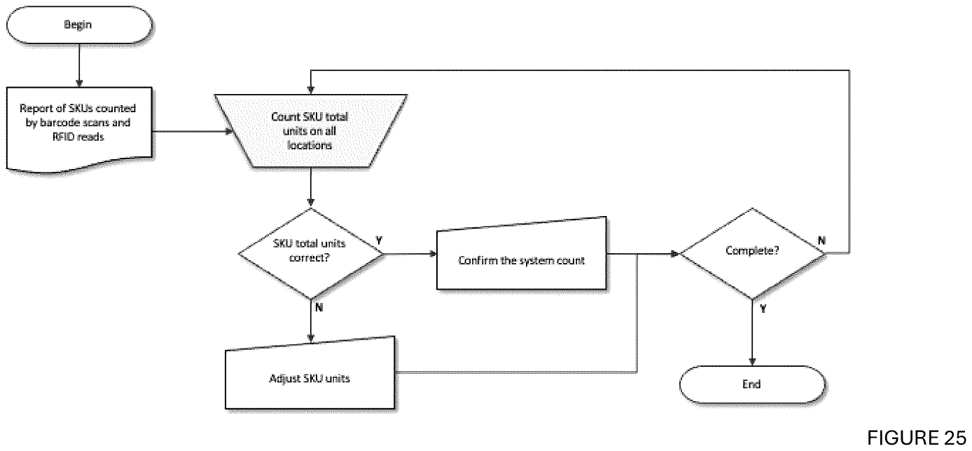

FIG. 25 depicts a step of resolving SKUs counted both ways according to an embodiment of the present disclosure. The system may report all SKUs counted by both RFID reads and barcode scans. The user may manually count the total units for a reported SKU. If the units counted matches the RFID plus barcode counts, then the user confirms the RFID count and moves to the next SKU. If the units counted do not match the RFID plus barcode counts, the user will adjust the total units. The user repeats this process for all reported SKUs.

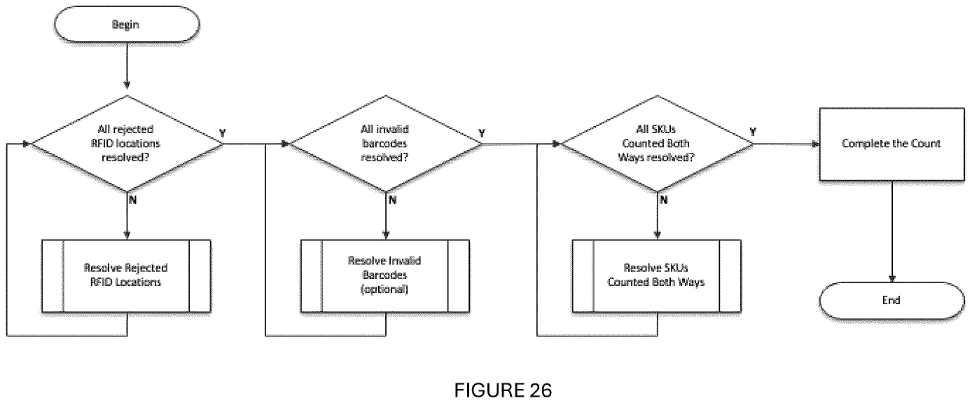

FIG. 26 depicts a step of completing the count according to an embodiment of the present disclosure. The business may complete the count when all of the following conditions are met: all data is collected for all location tags recorded as used (RFID reads, Unit counts); all rejected locations are resolved; and all invalid barcodes are resolved. The steps may be repeated until each of the conditions described above have been met.

Embodiments of the present disclosure may provide labor savings with respect to barcode scanning. It is estimated that use of systems and methods according to embodiments of the present disclosure may save approximately 70-90 percent of labor costs associated with barcode scanning depending on the number of barcode scans required due to failed total unit comparisons between the manual count on the location tag and the total RFID reads assigned by the system. For this estimate, reject rates may be between 5% and 20%.

Further embodiments of the present disclosure augment RFID reads with barcode scans and implement using RFID read attributes to report counts at a much lower level of location granularity. Limiting the physical area to audit can significantly reduce the time to audit which can result in more audits to increase the trust in an RFID count. In addition, the process according to embodiments of the present disclosure identifies product families which require counting by scanning barcodes, giving businesses increased confidence and trust in their final inventory counts. All of this can be beneficial when there are product families that do not have RFID tags or have unreadable RFID tags or when manufacturers have missed tagging the products, when it may not be feasible to tag certain product families, or when RFID tag manufacturers may have released defective tags before becoming aware of the mistake.

Embodiments of the present disclosure also may increase the effective read accuracy over a single RFID cycle count. For example, at one retail location, use of systems and methods according to embodiments of the present disclosure may identify around 150 items without tags, which would never be found with current RFID counting practices. At another retailer, use of systems and methods according to embodiments of the present disclosure would have found RFID tags that are placed behind permanent fixtures, thereby allowing the retailer to properly exclude them from the final count.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for auditable radio frequency identification (RFID) counting comprising:
starting a count;
performing an RFID read of all items associated with each location tag;
associating the RFID read with a most likely location tag;
comparing the RFID read to onhands to identify any locations required to be re-read with RFID;
performing any RFID re-reads of any locations required to be re-read with RFID;
merging the RFID read and any RFID re-reads; and
completing the count by creating a final count file.

2. The method of claim 1 further comprising:
performing a barcode scan of at least one stock keeping unit (SKU) in each product family associated with each location tag, wherein the barcode scan is performed at or around the time when the RFID read step is performed;
comparing the RFID read to the barcode scan; and
performing barcode counts, wherein the barcode scan is merged with the RFID read and any RFID re-reads.

3. The method of claim 2, wherein a file containing SKUs and associated locations is used in lieu of performing the barcode scan.

4. The method of claim 1 further comprising:
performing one or more audit counts of the merged reads.

5. The method of claim 1, wherein each location tag has a printed barcode, a human-readable location identifier, a non-repeating serial number unique with a business location, and optionally RFID or other wireless technology.

6. The method of claim 1, wherein starting the count uses temporary location tags and/or permanent location tags through manual entry and/or automated entry.

7. The method of claim 6 further comprising:
affixing temporary location tags to all locations in an area to be counted;
entering all used location tags; and
entering a scope of the count.

8. The method of claim 6 further comprising:
entering all used location tags; and
entering a scope of the count.

9. The method of claim 6 further comprising:
entering a scope of the count;
starting the count; and
loading location tags from a known set of permanent tags.

10. The method of claim 1, the performing an RFID read of all items associated with each location tag further comprising:
scanning a location tag barcode or reading a location tag chip to indicate a location being counted;
analyzing incoming unique reads per second; and
providing a visual and/or audio indication when scanning or reading is to stop by combining incoming unique reads per second with minimum and maximum read times.

11. The method of claim 1, the associating the RFID read with a most likely location tag further comprising:
evaluating if all product families are processed;
if not all product families are processed, obtaining an RFID read along with barcode scan information for a next product family;
evaluating whether the next product family is in the count scope;
if not in the count scope, determining if the next product family is found on any barcode scan locations; and
if the next product family is found, associating a location of the barcode scan for the product family to all item instances in the next product family.

12. The method of claim 11, the associating step further comprising:
for each SKU within the product family, associating a location of a best RFID read of any item instance within that SKU.

13. The method of claim 1, the comparing the RFID read to onhands to identify any locations required to be re-read with RFID step further comprising:
identifying SKUs and/or product families that may have been undercounted; and
when a variance exceeds a threshold, scheduling RFID re-reads for all locations associated with the SKUs and/or product families.

14. The method of claim 1, the performing any RFID re-reads of any locations required to be re-read with RFID step further comprising:
if not all locations are read, performing a barcode scan, an electronic read, and/or manual entry of the location tag;
performing an RFID read of items in an area defined by the location tag;
closing location tag reads; and
uploading location data.

15. The method of claim 1, the merging the RFID read and any RFID re-reads step further comprising:
adding new item instances found in the RFID re-reads to the RFID read;
associating all RFID reads with location tags, overwriting any previous associations;
deleting any barcode counts for SKUs with any number of RFID reads; and
merging associated RFID reads with cleaned barcode counts to create final counts.

16. The method of claim 4 further comprising:
selecting a location to audit;
reporting unit counts for all SKUs associated with the location either by RFID reads or by barcode counts; and
reviewing the unit counts and modifying as needed.
